(19) United States
(12) Patent Application Publication
(10) Pub. No.: US 2004/0099154 A1
(43) Pub. Date: May 27, 2004

(54) Fluid distribution apparatus

(76) Inventor: Peter Raschle, Shepparton-Victoria (AU)

Correspondence Address: NIXON PEABODY, LLP, 401 9TH STREET, NW, SUITE 900, WASINGTON, DC, 20004-2128, US

(21) Appl. No.: 10/333,246

(22) PCT Filed: Jul. 20, 2001
(86) PCT No.: PCT/EP01/08385

(30) Foreign Application Priority Data
Jul. 20, 2000 (AU) PQ 8887

(51) Int. Cl. A01J 11/04

(52) U.S. Cl. 99/467

(57) ABSTRACT

The present invention relates generally to apparatus (1) for distributing fluid within an autoclave (2). The invention is suitable for use in applications in which the autoclave (2) is used to cook or sterilise food or beverages.

The present invention relates generally to apparatus for distributing steam or other fluid within an autoclave. The invention is suitable for use in applications in which the autoclave is used to cook or sterilise food or beverages, and it will be convenient to hereinafter describe the invention in relation to that exemplary, non limiting application.

Within the food processing industry it is known to use an autoclave for sterilising or cooking food products packed in any type of packing, for example cans pouches etc., using super heated steam or water under pressure. Autoclaves used in these applications include an upper fluid distributor extending across the entirety of the food to be processed, and a lower fluid collector extending across the base of the autoclave to collect and reuse the fluid in the autoclave.

In order to ensure uniformity of cooking of the food, it is important that the fluid used to process the food be uniformly distributed across the upper surface of the food products into the autoclave and that the fluid uniformly gravitates through the food products in the autoclave. Existing fluid distribution apparatus for use in such applications have been found to inadequately meet these criteria.

It would therefore be desirable to provide a fluid distribution apparatus which optimises the uniformity of the distribution and gravitation of the fluid used to process products within an autoclave.

It would also be desirable to provide a fluid distribution apparatus which ameliorates or overcomes one or more disadvantages of known fluid distribution apparatus.

With this in mind, one aspect of the present invention provides a fluid distribution apparatus comprising an autoclave including a fluid distributor and a fluid collection and a plurality of stacks of two or more fluid cascading canisters housed within said autoclave, wherein the top canister in each stack is in fluid communication with the fluid distributor, the bottom canister in each stack is in fluid communication with the fluid collector and adjacent canisters in each stack are in fluid communication with each other.

Preferably, each canister includes a fluid collection plate for collecting fluid within that canister. A plurality of apertures may be provided in each fluid collection plate enabling the draining of the collected fluid into a lower adjacent canister.

The fluid collection plate may be mounted within each canister, so that upon stacking of the canisters, the fluid collection plate is offset from horizontal to enable collected fluid to accumulate along a first side of the plate. The offset of the fluid collection plate may typically be from 1 to 45 degrees, and may preferably be 5 degrees.

The apertures in the fluid collection plate may be dimensioned to have an increasing diameter with distance from the first side of the plate mainly to compensate the fluid level differences.

The apertures may be formed within a plurality of fluid lines running in a first direction across the plate. The plate may include a plurality of fluid channels running in a second direction across said plate. Both measures for uniform distribution of the fluid within the canister.

Another aspect of the present invention provides a fluid cascading canister for use in a fluid distribution apparatus comprising an autoclave including a fluid distributor and a fluid collector, said canister forming part of a first of a plurality of stacks of two or more canisters housed within the autoclave, wherein said canister is in fluid communication with an immediately adjacent canister in said first stack.

A further aspect of the present invention comprises a fluid collection plate for use in a fluid cascading canister forming part of a fluid distribution apparatus comprising an autoclave including a fluid distributor and a fluid collector, said canister forming part of a first of a plurality of stacks of two or more canisters housed within the autoclave, wherein the canister is in fluid communication with an immediately adjacent canister in the first stack, said fluid collection plate acting to collect fluid from within said canister.

Another further aspect of the present invention comprises a fluid cascading canister for use in a fluid distribution apparatus.

In order to assist in arriving at an understanding of the present invention, one embodiment is illustrated in the attached drawings. However, it is to be understood that the following is illustrative only and should not be taken in any way as a restriction on the generality of the invention as described above.

In the drawings:

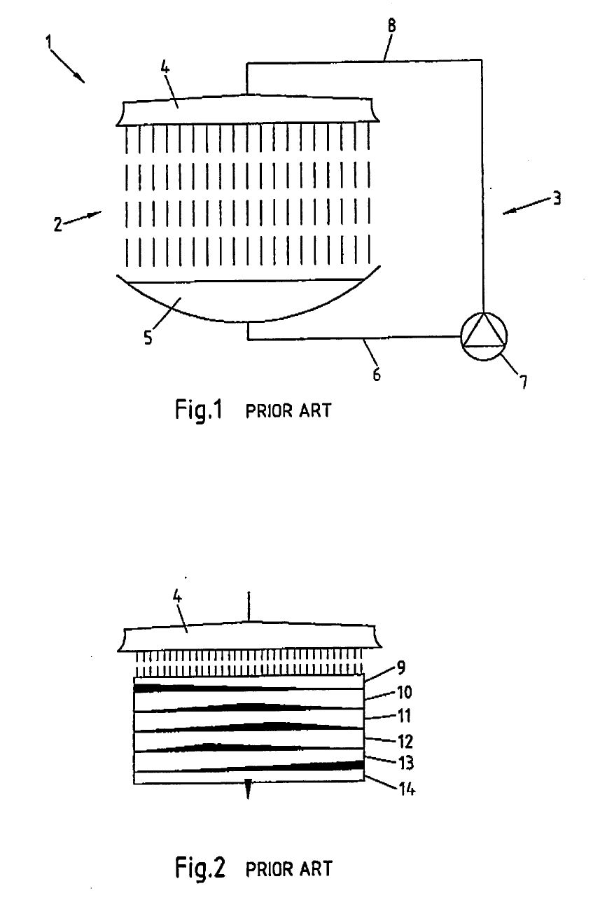

FIG. 1 is a schematic diagram showing a prior art fluid distribution apparatus;

FIG. 2 is a schematic diagram showing a stack of prior art food processing trays for use in conjunction with the fluid distribution apparatus of FIG. 1;

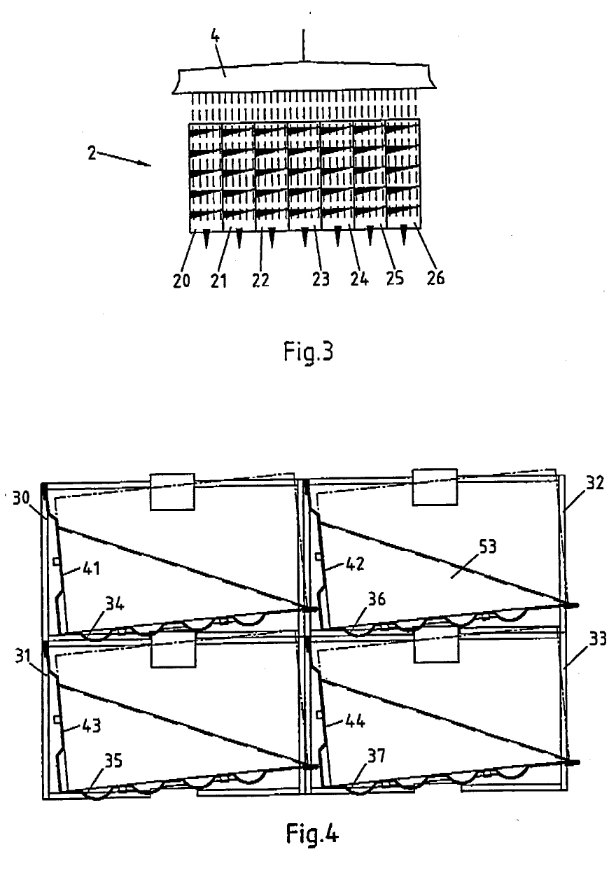

FIG. 3 is a schematic diagram showing one embodiment of a fluid distribution apparatus according to the present invention;

FIG. 4 is a detailed view of four fluid cascading canisters used in the fluid distribution apparatus of FIG. 1; and

FIGS. 5 to 7 are respectively a plan view, a side view and a perspective view of a fluid collection plate for use in the fluid distribution apparatus of FIGS. 3 and 4.

Referring now to FIG. 1, there is shown generally a fluid distribution apparatus 1 comprising an autoclave 2 and fluid recycling system 3. The autoclave 2 includes a fluid distributor 4 for applying fluid to the food or other products within the autoclave 2. In this example, the fluid distributor 4 applies a shower of hot or cold water across the width of an upper portion of the autoclave 2, however in other examples steam or other fluids may be used to process the products within the autoclave 2.

The autoclave 2 also includes a fluid collector 5 for collecting the fluid from within the autoclave 2. This collected fluid is supplies by a return line 6 to a pump 7 and, in this example, a water heater (not shown). The heated water is returned to the fluid distributor 4 via a fluid return line 8.

As shown in FIG. 2, in conventional fluid distribution apparatus, food products to be processed are typically placed within the autoclave 2 in a stack of trays 9 to 14. The top tray 9 is open on its upper side in order that heated water from the fluid distributor 4 is able to be applied to the food products in that tray. An aperture is formed in the base of each of the trays 9 to 14 in order that the fluid in each tray is able to gravitate to a lower adjacent tray. The aperture in the lowermost tray 14 enables the heated water to be collected by the fluid collector 5. It can be appreciated that in such an arrangement, the disbursement of the hot water or other fluid in each of the trays 9 to 14 can shift in an uncontrolled manner across the lower surface of each tray. Such varying liquid distribution results in a non-uniform gravitation of the fluid from one tray to the next within the stacks of trays illustrated in FIG. 2. Moreover, the food products located centrally within each tray receive a more direct application of the fluid than do those food products located at the periphery of the trays, further adding to the non-uniform processing of the food products within the autoclave 2.

These problems are addressed in the present invention by the provision of a plurality of stacks of two or more fluid cascading canisters housed within the autoclave. In the example shown in FIG. 3, stacks 20 to 26 of 5 canisters each are housed within the autoclave 2. The top canister in each stack 20 to 26 is in fluid communication with the fluid distributor 4 such that hot water or other fluid from the fluid distributor 4 is applied to the food or other products within each topmost canister. Each of the adjacent canisters in each stack 20 to 26 are in fluid communication with each other, whilst the bottom canister in each stack 20 to 26 is in fluid communication with the fluid collector 5 to recover fluid for subsequent reuse.

The manner in which the fluid cascading canisters are arranged in the autoclave 2 will be better appreciated from FIG. 4, which shows two canister 30 and 31 from a first stack, and two canisters 32 and 33 from a second stack, within the autoclave 2. Fluid collection plates 34 to 37 are respectively mounted within canisters 30 to 33. Each fluid collection plate 34 to 37 is mounted within its respective canister so that, upon stacking of the canisters, the fluid collection plate is offset from the horizontal by an angle α. Angles of 1 to 45 degrees, and preferably 5 degrees, have been found to be suitable for use in many applications.

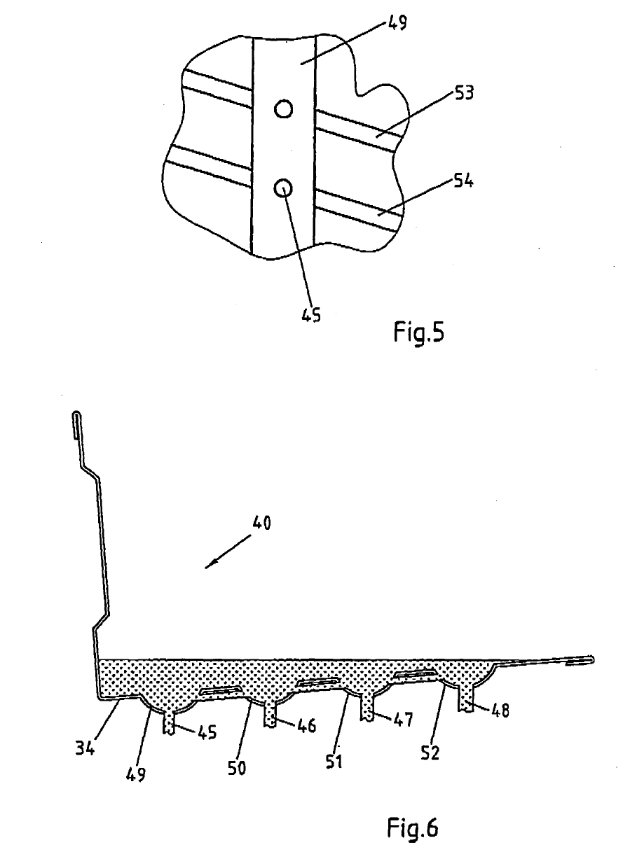

As shown in FIG. 6, such an offset enables fluid collected within the canister to be accumulated along a first side 40, of the plate 34 (the left side as seen in FIGS. 4 and 6). Mounting brackets or walls 41 to 44 may project respectively from fluid collection plates 34 to 37 in order to enable the fluid collection plates to be mounted within the canisters, respectively 30 to 33.

Each fluid collection plate includes a plurality of apertures, referenced 45 to 48 in FIG. 6, to enable the draining of the collected fluid into a lower adjacent canister within each stack.

The apertures may be formed within a plurality of fluid lines 49 to 52 running in a first direction across the fluid collection plate 34. The apertures may be dimensioned to have increasing diameter with distance from the first side 40 of the plate 34. Accordingly, the apertures in the fluid line 49 may have a smaller diameter than the apertures in the fluid line 50, and so on. In this way, uniformity of liquid flow from the apertures in the fluid collection plate to a lower adjacent canister is obtained.

The fluid collection plate may also include a plurality of fluid channels 53 and 54 running in a second direction across the plate.

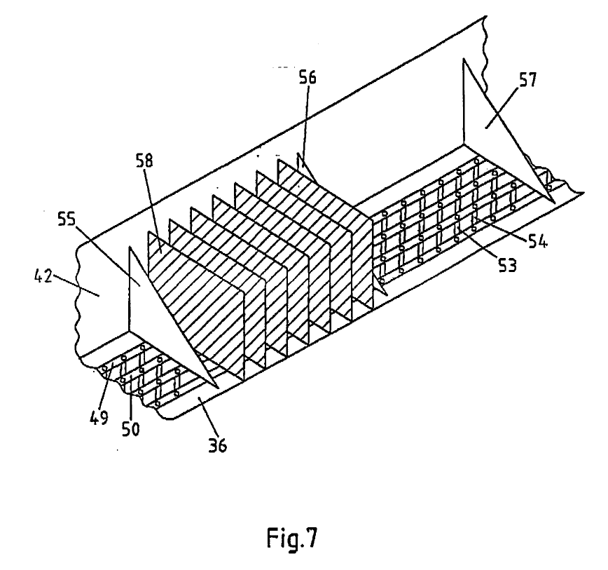

Separate baffles may also be provided within each of the canisters 32, 33 in order to maintain products within each canister in position. Examples of such separation baffles are referenced 55, 56 and 57 in FIG. 7. In this example pouches 58 are stacked in between the separation baffles 55, 56.

It will be appreciated that the present invention enables the uniform distribution and gravitation of fluid within the autoclave 2 to be optimised and made more uniform in order that variations in product heating, cooling or other processing can be minimised.

Finally, it is to be understood that various modifications and/or additions may be made to the present invention described herein.

1. Fluid distribution apparatus (1) comprising an autoclave (2) including a fluid distributor (4) and a fluid collector (5) and a plurality of stacks (20-26) of two or more fluid cascading canisters (30, 31, 32, 33) housed within said autoclave (2), wherein the top canister in each stack (20-26) is in fluid communication with the fluid distributor (4), the bottom canister in each stack (20-26) is in fluid communication with the fluid collector (5) and adjacent canisters in each stack (20-26) are in fluid communication with each other.

2. Fluid distribution apparatus (1) according to claim 1, characterized in that each canister (30, 31, 32, 33) includes a fluid collection plate (34, 35, 36, 37) for collecting fluid within said canister (30, 31, 32, 33), said fluid collection plate (34, 35, 36, 37) being provided with a plurality of apertures (45, 46, 47, 48).

3. Fluid distribution apparatus (1) according to claim 1 or 2, characterized in that said fluid collection plate (34, 35, 36, 37) is mounted in a canister (30, 31, 32, 33) so that upon stacking of said canisters (30, 31, 32, 33), said fluid collection plate (34, 35, 36, 37) is offset from horizontal to enable collected fluid to accumulate along a first side (40) of said fluid collection plate.

4. Fluid distribution apparatus (1) according to claim 3, characterized in that the offset of said fluid collection plate (34, 35, 36, 37) is in between 1 to 45 degrees, preferably 5 degrees.

5. Fluid distribution apparatus (1) according to one of claims 2 to 4, characterized in that said apertures (45, 46, 47, 48) in said fluid collection plate (34, 35, 36, 37) having an increasing diameter with distance from the first side (40) of said fluid collection plate.

6. Fluid distribution apparatus (1) according to one of claims 2 to 5, characterized in that said apertures (45, 46, 47, 48) are formed within a plurality of fluid lines (49, 50, 51, 52) running in a first direction across said fluid collection plate.

7. Fluid distribution apparatus according (1) to one of claims 1 to 6, characterized in that said fluid collection plate includes a plurality of fluid channels (53, 54) running in a second direction across said fluid collection plate

8. Fluid cascading canister (30, 31, 32, 33), especially for use in a fluid distribution apparatus (1) comprising an autoclave (2) including a fluid distributor (4) and a fluid collector (5) according to one of claims 1 to 7, said canister (30, 31, 32, 33) forming part of a first of a plurality of stacks (20-26) of two or more canisters housed within the autoclave (2), wherein said canister (30, 31, 32, 33) is in fluid communication with an immediately adjacent canister in said first stack.

9. Fluid collection plate (34, 35, 36, 37), especially for use in a fluid cascading canister (30, 31, 32, 33) forming a part of a fluid distribution apparatus (1), comprising an autoclave (2) including a fluid distributor (4) and a fluid collector (5) according to one of claims 1 to 7, said canister (30, 31, 32, 33) forming part of a first of a plurality of stacks (20-26) of two or more canisters housed within the autoclave (2) wherein said canister (30, 31, 32, 33) is in fluid communication with an immediately adjacent canister in the first stack, said fluid collection plate acting to collect fluid from within said canister (30, 31, 32, 33).

10. Fluid cascading canister for use in a fluid distribution apparatus according to claims 1 to 7.
